(19) United States
(12) Patent Application Publication
(10) Pub. No.: US 2008/0035268 A1
(43) Pub. Date: Feb. 14, 2008

(54) Apparatus, Composition, and Method to form an Image on a Substrate

(76) Inventor: Rick Duarte, San Lorenzo, CA (US)

Correspondence Address: DALE F. REGELMAN, CHANDLER & UDALL, LLP, 4801 E. BROADWAY BLVD #400, TUCSON, AZ, 85711-3609, US

(21) Appl. No.: 11/574,322

(22) PCT Filed: Feb. 10, 2006
(86) PCT No.: PCT/US06/04724

§ 371 Date: Feb. 27, 2007

Related U.S. Application Data
(60) Provisional application No. 60/651,765, filed on Feb. 10, 2005.

(51) Int. Cl. B05D 1/00

(52) U.S. Cl. 156/241; 156/578

(57) ABSTRACT

A method is disclosed to form an image on a substrate. The method supplies an adhesive applicator (200) comprising a housing (210), a porous carrier (220) disposed within said housing and extending outwardly therefrom, and an adhesive releaseably disposed within that porous carrier. The method further provides a substrate (510) and a plurality of particles (810). The method contacts all or part of the substrate with an adhesive-coated image-bearing surface (320) to form one or more adhesive-bearing portions (610) on the substrate (510). The method then disposes the plurality of particles (810) onto those one or more adhesive-bearing portions (610) of the substrate (510) to form an image on the substrate.

### CROSS REFERENCE TO RELATED APPLICATIONS

This Application claims priority from a Provisional Application having Ser. No. 60/651,765 filed Feb. 10, 2005.

### FIELD OF THE INVENTION

The invention relates to an adhesive applicator comprising an adhesive, and method using that adhesive applicator to form an image on a substrate.

### BACKGROUND OF THE INVENTION

Methods are known in the art to form an image onto a substrate using a stamping apparatus and inks. What is needed is an apparatus and method to form an image on a substrate, wherein that image comprises a plurality of particles, where that plurality of particles comprises one or more powders, metal particles, metal leaf, and the like.

### SUMMARY OF THE INVENTION

Applicant's invention comprises a method to form an image on a substrate. The method supplies an adhesive applicator comprising a housing, a porous carrier disposed within the housing and extending outwardly therefrom, and an adhesive removeably disposed within that porous carrier. The method further provides a substrate and a plurality of particles.

The method contacts all or part of the substrate with the porous carrier to form one or more adhesive-bearing portions of the substrate. The method then disposes the plurality of particles onto those one or more adhesive-bearing portions of the substrate to form an image on the substrate.

### BRIEF DESCRIPTION OF THE DRAWINGS

The invention will be better understood from a reading of the following detailed description taken in conjunction with the drawings in which like reference designators are used to designate like elements, and in which:

FIG. 1 is a flow chart summarizing the steps of Applicant's method;

FIG. 2A is a perspective view of one embodiment of Applicant's adhesive applicator;

FIG. 2B is a cross-sectional view of a second embodiment of Applicant's adhesive applicator;

FIG. 3 is a perspective view of a hand-held stamp apparatus comprising an image-bearing surface;

FIG. 4 shows the image-bearing surface of the apparatus of FIG. 3 in contact with adhesive-containing carrier portion of the adhesive applicator of FIG. 2A;

FIG. 5 shows the adhesive-carrying image-bearing surface of the apparatus of FIG. 3 in contact with a substrate;

FIG. 6 shows a perspective view of the adhesive-bearing portion of the substrate of FIG. 5;

FIG. 7 shows a top view of the adhesive-bearing portion of the substrate of FIG. 5; and

FIG. 8 shows an image formed by plurality of particles disposed on the adhesive-bearing portion of the substrate of FIG. 5.

### DETAILED DESCRIPTION OF THE PREFERRED EMBODIMENTS

Applicant's invention facilitates the formation of an image on a substrate, wherein that image comprises one or more desired ornamental properties, including, without limitation, one or more colors, one or more sizes, one more or more textures, optionally in combination with one or more additional characteristics, which include, without limitation, light reflectivity, light absorptivity, reflection angle, number of reflection surfaces, fluorescence, phosphorescence, and the like. The invention is described herein with reference to the Figures, in which like numbers represent the same or similar elements.

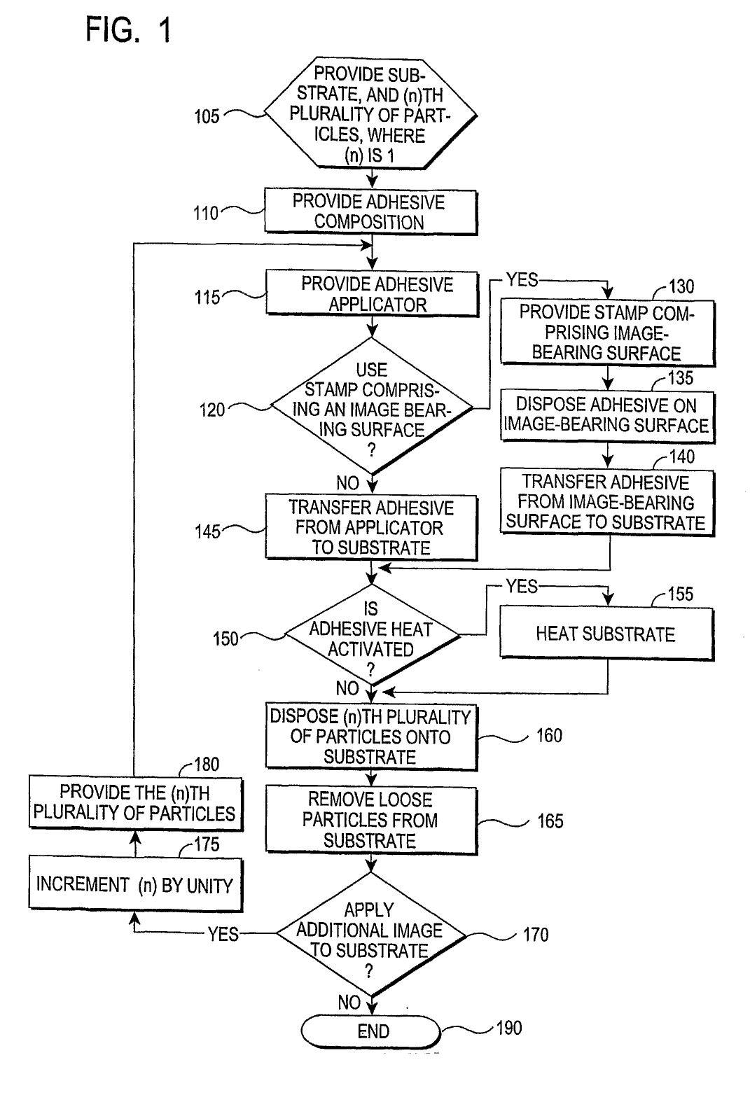

Referring now to FIG. 1, in step 105 Applicant's method provides a substrate and a first plurality of particles, wherein those particles will be used to define the desired image on the substrate. If more than one kind of image will be disposed on the substrate, then the method of FIG. 1 is repeated using a second plurality of particles.

By “plurality of particles,” Applicant means an assemblage of individual objects wherein, on the average, each of those individual objects has a longest dimension less than about 0.10 inch. In certain embodiments, each of the plurality of particles has a spherical shape. In other embodiments, each of the plurality of particles comprises the shape of a parallelepiped. In still other embodiments, each of the plurality of particles has an irregular shape.

In certain embodiments, the plurality of particles of step 105 includes one or more crystalline materials. In certain embodiments, the plurality of particles of step 105 includes one or more glasses. In certain embodiments, the plurality of particles of step 105 includes one or more liquid crystalline materials.

In certain embodiments, the plurality of particles of step 105 comprises a powder having one or more desired properties, such as, without limitation, color, size, texture, light reflectivity, light absorptivity, reflection angle, number of reflection surfaces, fluorescence, phosphorescence, and the like. Examples include, without limitation, iron oxide particles having a red color, titanium dioxide particles having a white color, graphite particles having a black color, and the like. In certain embodiments, the plurality of particles of step 105 comprise metallic pigments sold in commerce by Houston Art. In certain embodiments, the plurality of particles of step 105 comprise metallic pigments sold in commerce under the trade name Pearl Ex by Rupert Gibbon & Spyder.

In certain embodiments, the plurality of particles of step 105 comprises metal particles having one or more desired properties, such as, without limitation, color, texture, size, light reflectivity, light absorptivity, reflection angle, number of reflection surfaces, fluorescence, phosphorescence, and the like.

In certain embodiments, the plurality of particles of step 105 comprises plastic particles having one or more desired properties, such as, without limitation, color, size, texture, light reflectivity, light absorptivity, reflection angle, number of reflection surfaces, fluorescence, phosphorescence, and the like. In certain embodiments, the plurality of particles of step 105 comprises metal leaf having one or more desired properties, such as, without limitation, color, size, texture, light reflectivity, light absorptivity, reflection angle, number of reflection surfaces, fluorescence, phosphorescence, and the like. In certain embodiments, the plurality of particles of step 105 comprise metal leaf sold in commerce by Houston Art.

In step 110, Applicant's method provides an adhesive formulation. In certain embodiments, Applicant's adhesive formulation comprises a heat-activated adhesive. By “heat-activated adhesive,” Applicant means an adhesive comprising at least one polymeric material that undergoes a first order thermal transition, such as for example melting, and/or a second order thermal transition, such as for example transition from a glass to a fluid, at one or more temperatures less than about 100° C.

In certain embodiments, Applicant's adhesive comprises one or more first polymeric materials, such as without limitation, polyvinyl alcohol, polyvinyl acetate, polyvinyl acetal, polyvinylpyrrolidone, poly-2-ethyl oxazoline, combinations thereof, and the like. In certain embodiments, Applicant's first polymeric material comprises polyvinyl acetate. By “polymeric material,” Applicant means a material having a molecular weight greater than about 1,000 Daltons.

In certain embodiments, Applicant's first polymeric material has a glass transition temperature less than about 100° C. In certain embodiments, Applicant's first polymeric material has a glass transition temperature less than about 50° C. In certain embodiments, Applicant's first polymeric material comprises a glass transition temperature in the absence of solvent(s) in the range of from about 35° C. to about 40° C.

In certain embodiments, Applicant's first polymeric material comprises between about 10 to about 50 weight percent of Applicant's adhesive. In other embodiments, Applicant's first polymeric material comprises between about 20 to about 40 weight percent of Applicant's adhesive. In other embodiments, Applicant's first polymeric material comprises about 30 weight percent of Applicant's adhesive.

In certain embodiments, Applicant's adhesive further comprises a second polymeric material, such as without limitation, one or more nylons, one or more polyamides, one or more polyimides, one or more polyurethanes, and the like. In certain embodiments, Applicant's second polymeric material comprises a polyurethane.

In certain embodiments, Applicant's second polymeric material comprises between about 1 to about 10 weight percent of Applicant's adhesive. In other embodiments, Applicant's second polymeric material comprises between about 2 to about 5 weight percent of Applicant's adhesive. In other embodiments, Applicant's second polymeric material comprises about 3 weight percent of Applicant's adhesive.

In certain embodiments, Applicant's adhesive further comprises a third polymeric material, such as without limitation, polyethylene oxide, polypropylene oxide, polyethylene glycol, and the like. In certain embodiments, Applicant's third polymeric material comprises polyethylene glycol.

In certain embodiments, Applicant's third polymeric material comprises between about 0 to about 10 weight percent of Applicant's adhesive. In other embodiments, Applicant's third polymeric material comprises between about 1 to about 8 weight percent of Applicant's adhesive. In other embodiments, Applicant's third polymeric material comprises about 5 weight percent of Applicant's adhesive.

In certain embodiments, Applicant's adhesive further comprises one or more organic solvents. By “organic solvents,” Applicant means a carbon-containing compound which is liquid at room temperature. Such organic solvents include, without limitation, alcohols, esters, ethers, hydrocarbons, glycols, glycol-ethers, combinations thereof, and the like. In certain embodiments, Applicant's adhesive comprises diethylene glycol. In certain embodiments, Applicant's adhesive comprises diethylene glycol monobutyl ether.

In certain embodiments, Applicant's one or more organic solvents comprise, in combination, between about 10 to about 50 weight percent of Applicant's adhesive. In other embodiments, Applicant's one or more organic solvents comprise, in combination, between about 20 to about 45 weight percent of Applicant's adhesive. In other embodiments, Applicant's one or more organic solvents comprise, in combination, about 42 weight percent of Applicant's adhesive.

In certain embodiments, Applicant's adhesive further comprises one or more fillers, such as, without limitation, clay, talc, combinations thereof, and the like. In certain embodiments, Applicant's one or more fillers comprise between about 0 to about 20 weight percent of Applicant's adhesive. In other embodiments, Applicant's one or more fillers comprise between about 5 to about 15 weight percent of Applicant's adhesive. In other embodiments, Applicant's one or more fillers comprise about 10 weight percent of Applicant's adhesive.

The above-recited components of Applicant's adhesive are disposed in water. In certain embodiments, the water comprises between about 10 to about 50 weight percent of Applicant's adhesive. In other embodiments, the water comprises between about 15 to about 40 weight percent of Applicant's adhesive. In other embodiments, the water comprises about 25 weight percent of Applicant's adhesive.

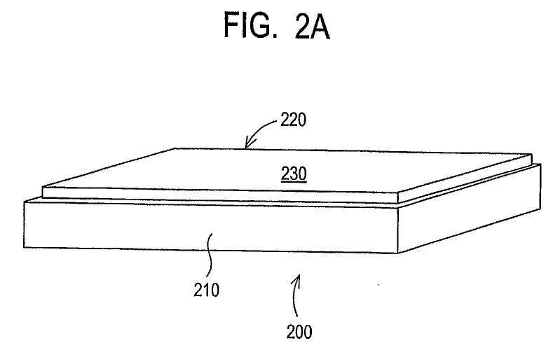

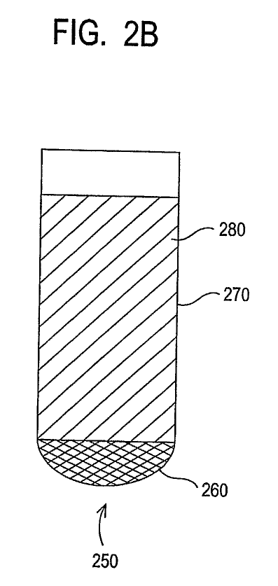

In step 115, Applicant's method provides an applicator for Applicant's adhesive formulation. In certain embodiments, the applicator of step 115 comprises a glue pad. For example and referring now to FIG. 2A, Applicant's glue pad 200 comprises a housing 210, a carrier material 220 disposed within the housing and extending outwardly therefrom, and the adhesive of step 110 releaseably disposed within carrier 220. In certain embodiments, carrier material 220 comprises one or more porous materials including, without limitation, felt, foam, linen and the like. By “porous material,” Applicant means a material formed to include a plurality of apertures.

In certain embodiments, the applicator of step 115 comprises an adhesive dauber, such as dauber applicator 250 (FIG. 2B). Dauber applicator 250 comprises housing 270, the adhesive of step 110 disposed within that housing, and carrier 260 disposed within housing 270 and extending outwardly therefrom. In certain embodiments, housing 270 comprises a cylinder having an open end. In certain embodiments, housing 270 is formed from one or more metals, such as without limitation aluminum. In certain embodiments, housing 270 is formed from one or more polymeric materials, such as without limitation polyethylene.

Carrier 260 is disposed within housing 270 and extends outwardly through the open end of housing 270. Carrier comprises a porous material, such as without limitation foam, linen, felt, and the like. Adhesive 280, i.e. the adhesive of step 110, is disposed within housing 270 and is releaseably disposed within carrier 260.

When dauber applicator 250 is disposed in the orientation shown in FIG. 2B with carrier 260 disposed downwardly, adhesive 280 is released from the plurality of apertures formed in carrier 260.

Referring again to FIG. 1, step 115 further comprises disposing the adhesive formulation of step 110 into the applicator of step 115. In certain glue pad embodiments, Applicant's adhesive formulation comprises between about 20 weight percent and about 40 weight percent of the combined weight of the carrier 220 (FIG. 2A) and that adhesive formulation.

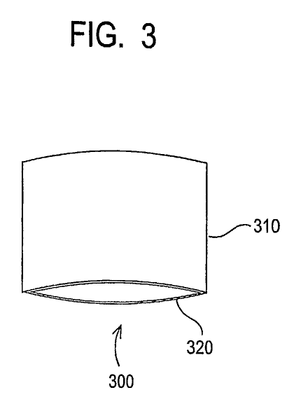

In step 120, Applicant's method determines whether to use a hand-held stamp apparatus comprising an image-bearing surface. If a hand-held stamp apparatus is being used, then Applicant's method transitions from step 120 to step 130 wherein the method provides the hand-held stamp apparatus, such as apparatus 300 (FIG. 3), comprising an image-bearing surface.

Referring now to FIG. 3, apparatus 300 comprises a handle portion 310 and an image-bearing surface 320. In the illustrated embodiment of FIG. 3, image-bearing surface 320 comprises a cylinder, wherein that image-bearing surface defines a circular design. As those skilled in the art will appreciate, the desired image may comprise one or more alpha-numeric characters, one or more design features, and/or one or more alpha-numeric characters in combination with one or more design features. For the sake of clarity, FIG. 3 shows a stamp having an image-bearing surface comprising a circular design defined by a first circle having a first diameter and a second circle having a second diameter.

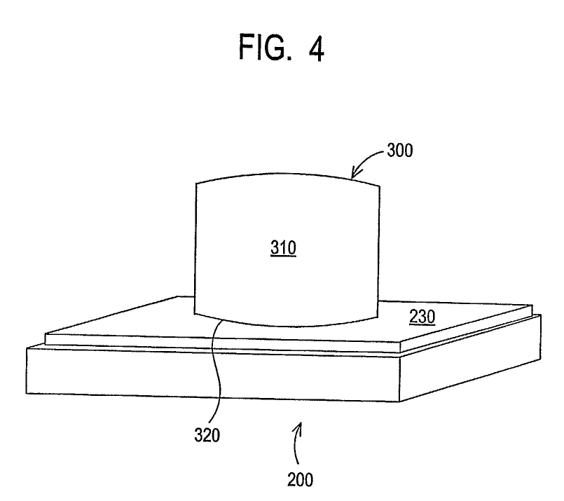

Referring again to FIG. 1, in step 135 Applicant's method disposes the adhesive formulation of step 110 onto the image-bearing surface of the stamp of step 130. For example, FIG. 4 shows hand-held stamp apparatus 300 in contact with surface 230 of carrier material 220, whereby Applicant's adhesive formulation is disposed on an image-bearing surface 320.

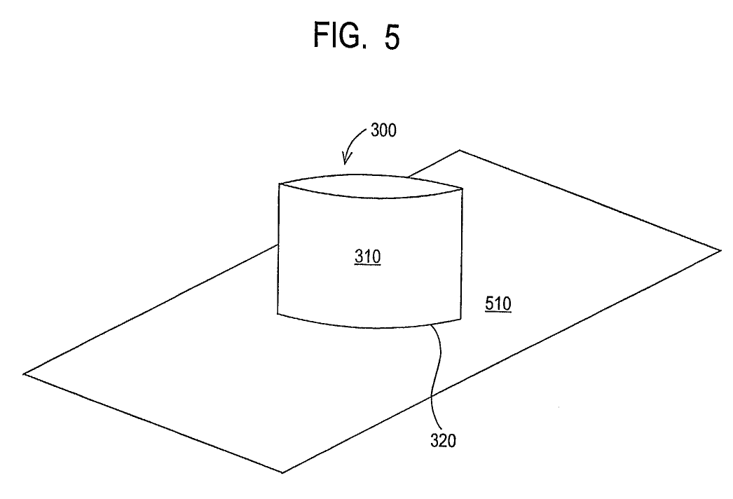

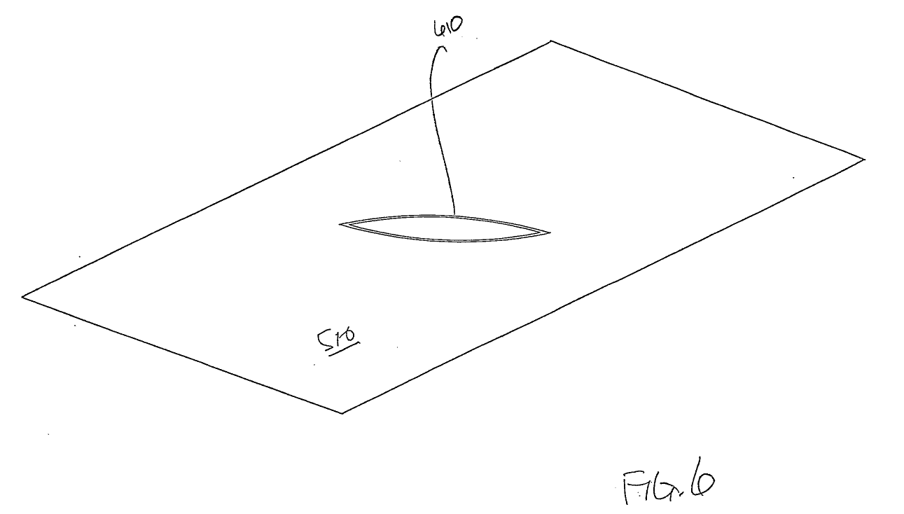

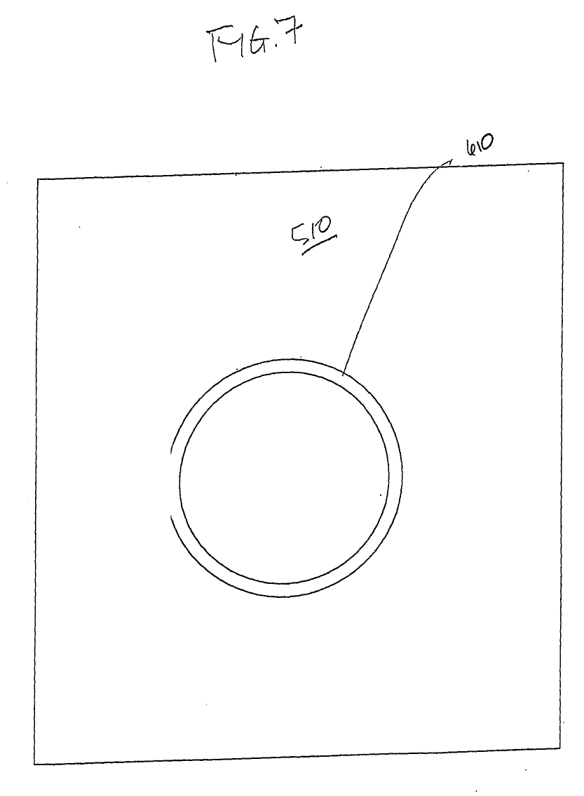

In step 140, Applicant's method transfers the adhesive formulation from the image-bearing surface, such as image-bearing surface 320, onto the substrate provided in step 105. For example, FIG. 5 shows hand-held stamping apparatus 300 with image-bearing surface 320 in contact with substrate 510. FIG. 6 shows substrate 510 after removal of apparatus 300 therefrom, with Applicant's adhesive remaining on adhesive-bearing portion 610, wherein Applicant's the adhesive transferred to substrate 510 defines the shape of image-bearing surface 320. FIG. 7 is a top view showing adhesive-bearing portion 610 disposed on substrate 510 in a circular design defined by image-bearing surface 320. Applicant's method transitions from step 140 to step 150.

If Applicant's method elects in step 120 not to use a stamping apparatus to transfer the adhesive of step 110 onto the substrate of step 105, then Applicant's method transitions from step 120 to step 145 wherein the method transfers the adhesive from the applicator to the substrate. In certain embodiments, step 145 comprises bringing all or part of the substrate of step 105 into contact with surface 230 of Applicant's glue pad 200 (FIGS. 2A, 4) thereby transferring the adhesive of step 110 from surface 230 (FIGS. 2A, 4) onto those portions of the substrate coming into contact with surface 230. In certain embodiments, step 145 comprises contacting all or part of the substrate of step 105 with carrier 260 (FIG. 2B) of dauber apparatus 250 (FIG. 2B) thereby transferring the adhesive of step 110 from carrier 260 onto those portions of the substrate coming into contact with that carrier.

Applicant's method transitions from step 145 to step 150 wherein Applicant's method determines whether the adhesive selected in step 115 comprises a heat-activated adhesive, as defined hereinabove. If Applicant's method determines in step 150 that the adhesive of step 110 comprises a heat-activated adhesive, then the method transitions from step 150 to step 155 wherein the method heats the substrate bearing the transferred adhesive.

In certain embodiments, step 140 comprises selectively heating the adhesive, such as Applicant's adhesive, disposed on the substrate, such as substrate 510. In certain embodiments, step 155 comprises heating the adhesive, such as Applicant's adhesive, to a temperature greater than the glass transition temperature of one or more of its components, such as for example Applicant's first polymeric material.

In certain embodiments, step 155 includes using a convection oven, wherein the substrate bearing the adhesive is placed in the oven. In other embodiments, the substrate bearing the adhesive is placed on a platen which is moved through the oven. In other embodiments, step 155 comprises using a hand-held heating device, such as a heat gun, hair dryer, and the like. Applicant's method transitions from step 155 to step 160.

If Applicant's method determines in step 150 that the adhesive of step 110 does not comprise a heat-activated formulation, then the method transitions from step 150 to step 160 wherein Applicant's method disposes the (n)th plurality of particles provided in step 105 or step 180 over the adhesive-bearing portion(s) of the substrate. In certain embodiments, the particles are sprinkled onto the substrate by hand. In other embodiments, the particles are released from a gravity feeder onto the substrate. In yet other embodiments, the particles are sprayed onto the substrate.

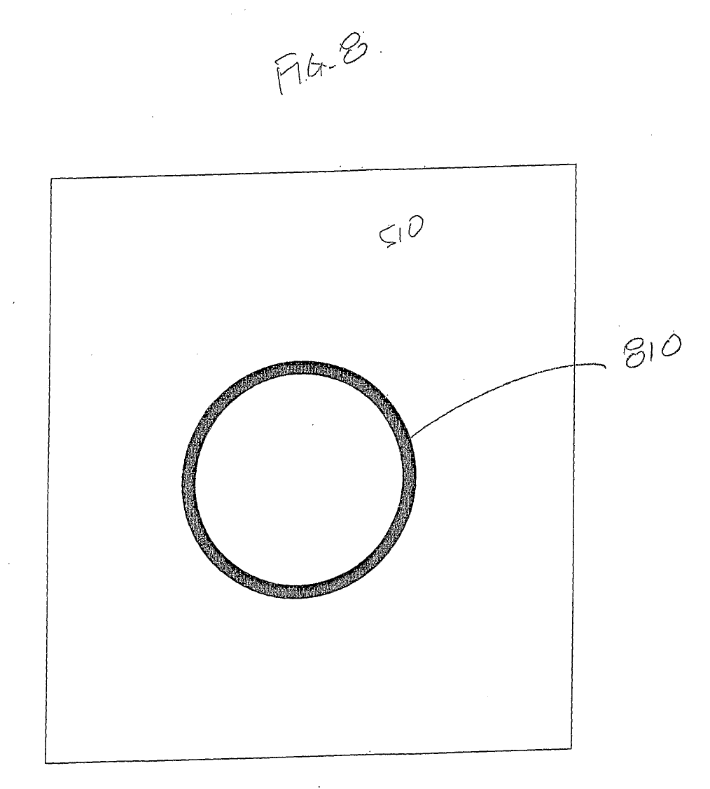

In step 165, Applicant's method removes the loose particles from the substrate. FIG. 8 shows a circular design formed on substrate 510 using Applicant's method, Applicant's adhesive, and image-bearing surface 320, wherein the plurality of particles 810 comprises graphite. In certain embodiments, step 165 further comprises shaking the substrate to remove the loose particles.

Using prior art methods, forming an image on a substrate wherein that image comprises a metal leaf requires at least 30 minutes between steps 160 and 165. In contrast adhering metal leaf particles to a substrate using Applicant's heat-activated adhesive, step 165 may be performed in only 10 seconds after performing step 160.

In certain embodiments, step 165 further comprises brushing the substrate to remove the loose particles. In certain embodiments, In certain embodiments, step 165 further comprises directing an air stream across the surface of the substrate to remove the loose particles.

In certain embodiments, step 165 further comprises cooling the substrate to about room temperature. In certain embodiments, step 165 further comprises cooling the substrate to a temperature less than the glass transition temperature of each of the polymeric components of Applicant's adhesive formulation. In certain embodiments steps 160 and 165 are combined wherein the plurality of particles are sprayed onto the substrate, wherein the particles adhere to the adhesive-bearing portions of the substrate, the substrate cools, and the loose particles are removed from the substrate.

In step 170, Applicant's method determines whether an additional plurality of particles will be disposed onto the substrate to form one or more images. If Applicant's method determines in step 170 that an additional plurality of particles will not be disposed onto the substrate, then the method transitions from step 170 to step 190 and ends. Alternatively, if Applicant's method determines in step 170 that an additional plurality of particles will be disposed onto the substrate, then the method transitions from step 170 to step 175 wherein the method increments (n) by unity. For example, if a first plurality of particles has been disposed on the substrate of step 105 to form one or more images, then in step 175 (n) is set to 2.

In step 180, Applicant's method provides the (n)th plurality of particles, and Applicant's method transitions from step 180 to step 115 and continues as described herein.

While the preferred embodiments of the present invention have been illustrated in detail, it should be apparent that modifications and adaptations to those embodiments may occur to one skilled in the art without departing from the scope of the present invention as set forth in the following claims.

1. A method to form an image on a substrate, comprising the steps of:
supplying a glue pad consisting of a housing, a porous carrier disposed within said housing, and an adhesive releaseably disposed within said porous carrier;
providing a substrate;
providing a plurality of particles;
contacting all or part of said substrate with said porous carrier to form one or more adhesive-bearing portions on said substrate; and
disposing said plurality of particles onto said one or more adhesive-bearing portions of said substrate.

2. The method of claim 1, further comprising the step of:
providing a stamp apparatus comprising an image-bearing surface;
wherein said contacting step comprises:
contacting said image-bearing surface with said porous carrier; and
contacting said image-bearing surface with said substrate.

3. The method of claim 1, wherein said supplying step further comprises providing an adhesive comprising a glass transition temperature in the range of from about 35° C. to about 40° C., said method further comprising the step of heating said adhesive-bearing portions of said substrate to a temperature greater than said glass transition temperature prior to performing said disposing step.

4. The method of claim 1, wherein said supplying step further comprises supplying an adhesive comprising a first polymeric material, wherein said first polymeric material comprises between about 20 to about 40 weight percent of said adhesive.

5. The method of claim 4, wherein said first polymeric material comprises a glass transition temperature in the range of from about 35° C. to about 40° C.

6. The method of claim 4, wherein said supplying step further comprises supplying an adhesive comprising a second polymeric material.

7. The method of claim 6, wherein said second polymeric material comprises between about 1 to about 10 weight percent of said adhesive.

8. The method of claim 6, wherein said supplying step further comprises supplying an adhesive comprising a third polymeric material.

9. The method of claim 8, wherein said third polymeric material comprises between about 1 to about 8 weight percent of said adhesive.

10. The method of claim 8, wherein said supplying step further comprises supplying an adhesive comprising a solvent selected from the group consisting of diethylene glycol and diethylene glycol monobutyl ether.

11. The method of claim 10, wherein said solvent comprises between about 20 to about 45 weight percent of said adhesive.

12. A glue pad, consisting of:
a housing;
a porous carrier disposed within said housing; and
an adhesive releaseably disposed within said porous carrier.

13. The glue pad of claim 12, wherein said adhesive comprises a first polymeric material, wherein said first polymeric material comprises between about 20 to about 40 weight percent of said adhesive.

14. The glue pad of claim 13, wherein said first polymeric material comprises a glass transition temperature in the range of from about 35° C. to about 40° C.

15. The glue pad of claim 13, wherein said adhesive further comprises a second polymeric material.

16. The glue pad of claim 15, wherein said second polymeric material comprises between about 1 to about 10 weight percent of said adhesive.

17. The glue pad of claim 15, wherein said adhesive further comprises a third polymeric material.

18. The glue pad of claim 17, wherein said third polymeric material comprises between about 1 to about 8 weight percent of said adhesive.

19. The glue pad of claim 17, further comprising a solvent selected from the group consisting of diethylene glycol and diethylene glycol monobutyl ether.

20. The glue pad of claim 19, wherein said solvent comprises between about 20 to about 45 weight percent of said adhesive.
